(19) United States
(12) Patent Application Publication
(10) Pub. No.: US 2014/0315110 A1
(43) Pub. Date: Oct. 23, 2014

(54) Method for Operating a Fuel Cell

(71) Applicants: Felix Blank, Konstanz (DE); Steffen Dehn, Nersingen (DE); Matthias Jesse, Dettingen (DE); Cosimo Mazzotta, Ulm (DE); Martin Woehr, Weilheim (DE)

(72) Inventors: Felix Blank, Konstanz (DE); Steffen Dehn, Nersingen (DE); Matthias Jesse, Dettingen (DE); Cosimo Mazzotta, Ulm (DE); Martin Woehr, Weilheim (DE)

(73) Assignee: Daimler AG, Stuttgart (DE)

(21) Appl. No.: 14/343,577

(22) PCT Filed: Aug. 29, 2012
(86) PCT No.: PCT/EP2012/003626

§ 371 Date: Jun. 2, 2014

(30) Foreign Application Priority Data
Sep. 9, 2011 (DE) 10 2011 113 010.5

(51) Int. Cl. H01M 8/04

(52) U.S. Cl. CPC H01M 8/04097
USPC 429/414; 429/415

(57) ABSTRACT

A method for operating a fuel cell system involves operating the fuel cell with recirculation of anode exhaust gas below a predefined maximum load limit of the fuel cell and operating the fuel cell without recirculation of the anode exhaust gas between the load limit and the full load of the fuel cell.

### BACKGROUND AND SUMMARY OF THE INVENTION

Exemplary embodiments of the invention relate to a method for operating a fuel cell system.

Fuel cell systems are known from the general prior art, and utilize, for example, a fuel cell, which may be designed as a PEM fuel cell, to generate electrical energy from air, oxygen, and hydrogen. Fuel cell systems of this type may be used, for example, in motor vehicles for generating electrical drive power.

In principle, a fuel cell having a cathode chamber supplied with air and an anode chamber supplied with hydrogen or a hydrogen-containing gas may be operated in such a way that in particular the anode chamber is designed as an anode chamber that is closed on one side. If the anode chamber is supplied only with pure hydrogen, theoretically the hydrogen is completely reacted in the fuel cell, so that no media flow out of the anode chamber. In practice, this does not occur, or does not occur satisfactorily, since a small portion of the product water generated in the fuel cell develops in the area of the anode chamber, and since inert gases such as nitrogen could diffuse from the cathode chamber into the anode chamber. Instead of such an anode chamber that is closed on one side, also referred to as a dead end anode chamber, in practice a so-called near-dead end anode chamber is frequently used. The near-dead end anode chamber has an anode output, and is operated with a slight excess of hydrogen so that product water and inert gases from the unreacted residual hydrogen in the fuel cell may be discharged from the anode chamber. In principle this design is very simple and efficient, and with a suitable configuration, for example a cascaded design of the active surfaces of the anode chamber, may be operated with a very small excess of hydrogen. Here as well, however, a certain excess of hydrogen is necessary in order to securely and reliably discharge inert gases and in particular generated product water, and to prevent the product water from “blocking” an active surface.

In practice, it is customary to avoid the described problems by providing a recirculation system for anode exhaust gas and the anode chamber. In this design, the anode exhaust gas at the output of the anode chamber is led back via a recirculation line to the input of the anode chamber, and together with freshly metered hydrogen is resupplied to the anode chamber. The design allows the use of a comparatively large quantity of supplied hydrogen in relation to the quantity of hydrogen that is reacted in the anode chamber, and thus allows product water and inert gases to be reliably flushed from the anode chamber. In addition, a portion of the product water, which in particular is in vapor form, is transported back into the area of the anode chamber, thus improving the humidification of the anode chamber, which may be advantageous when a PEM fuel cell is used. However, such designs are comparatively complicated, and always require a recirculation conveying device for compensating for the pressure losses in the recirculation line and in the anode chamber. Such a recirculation conveying device typically comprises a blower, and/or one or more gas jet pumps which are connected in parallel or in series, depending on the power of the fuel cell system. Reference is made, for example, to German Unexamined Patent Application DE 102 51 878 A1, which describes a fuel cell system having a recirculation system for anode exhaust gas and the anode chamber. As is apparent in the cited patent application, even the simplest design is relatively complex, and requires appropriate installation space and a comparatively large recirculation conveying device in order to be able to conduct the necessary volume flow in the circuit around the anode chamber.

Another problem with such a recirculation for anode exhaust gas is that over time, product water and inert gases become concentrated in the area of the recirculation. Due to the constant volume of the recirculation line, the concentration of hydrogen drops and the performance of the fuel cell is impaired. It is therefore generally known and customary to exhaust water and inert gases, intermittently or continuously via a diaphragm, and to conduct them, for example, to the environment, to a catalytic unit, and/or to the intake air flow to the cathode chamber of the fuel cell.

Furthermore, it is known from the general prior art that exhaust gases from the anode chamber, which typically contain residues of hydrogen, may be post-combusted in a burner, preferably a catalytic burner. The exhaust gases may then be expanded via a turbine so that thermal energy and pressure energy in the exhaust gases may be recovered. Such a turbine may be used in particular for driving an air conveying device for the fuel cell. The turbine may preferably have a design that is combined with an electric machine, which then forms a so-called electric turbocharger (ETC). This ETC is designed in such a way that the electric machine typically provides the required drive power for the air conveying device in addition to the power recovered in the turbine. If more power is generated in the area of the turbine than is required by the air supply device, the electric machine may also be operated as a generator in order to generate electrical power on its own.

Exemplary embodiments of the present invention are directed to a method for operating a fuel cell system having a recirculation system for anode exhaust gas around the anode chamber, which has a very simple and compact design of the fuel cell system with good functionality of the fuel cell.

The method according to the invention provides that below a predefined load limit of the fuel cell, the fuel cell is operated with recirculation of anode exhaust gas, and that between the load limit and the full load of the fuel cell, the fuel cell is operated without such anode recirculation. The method according to the invention thus provides that, as a function of the load, a switch is made between a near-dead end anode chamber at higher loads up to full load, and an anode chamber with anode recirculation at part load. The major advantage is that at loads below the provided load limit, i.e., typically in the part load range, on the one hand humidification of the anode chamber is possible due to the recirculated water vapor, and on the other hand, operation may be carried out with a comparatively large excess of hydrogen without having to accept large hydrogen losses, so that the water may be completely discharged from the anode chamber despite the conditions in part load operation that are unfavorable for discharging water from the anode chamber. In addition, the required recirculation conveying device, preferably a gas jet pump, then has to be designed only for the part load flow, and may therefore be implemented in a compact, simple, and cost-effective manner.

For average and higher loads above the predefined load limit, a comparatively smaller excess of hydrogen is then sufficient to securely and reliably discharge product water and to securely and reliably operate the fuel cell, even with a small excess of hydrogen, which results in only small hydrogen losses to the environment or to a catalytic afterburner. This results overall in a very cost-effective approach which has distinct advantages with regard to energy efficiency, in particular compared to a recirculation blower that is operated up to full load. In addition, a fuel cell system that is operated using the novel method has a much smaller design, so that a higher power density is possible.

In one particularly preferred refinement of the method according to the invention, the predefined load limit is predefined as a function of the fuel cell current at up to 30 percent of the maximum fuel cell current at full load, preferably between 5 and 20 percent of the maximum fuel cell system at full load. In one particularly advantageous refinement, the predefined load limit is predefined as a function of the fuel cell current between 10 and 15 percent of the maximum fuel cell current at full load.

In this particularly advantageous embodiment of the invention, the part load range below the predefined load limit is thus comparatively small, and particularly preferably is in the range between 5 and 10 percent as the upper limit value. Only at loads below such a value, for example below approximately 12 percent of the maximum fuel cell current at full load, it is necessary to recirculate the anode exhaust gases around the anode chamber. Accordingly, a recirculation conveying device, which is preferably designed as a gas jet pump, may be implemented in a simple, compact, and efficient manner. In all other operating states, the anode chamber is operated as a near-dead end anode chamber having a minimum excess of hydrogen, which ensures sufficient good performance and enables a very simple and efficient design of the fuel cell system with high power density.

In one particularly beneficial and advantageous embodiment of the method according to the invention, below the predefined load limit the anode chamber is supplied with more than 1.5 times, preferably approximately 1.7 to 1.8 times, the required fuel. Such a so-called anode stoichiometry of greater than 1.5 thus utilizes 50 percent or more excess fuel that flows into the anode chamber. Thus, in any case it is ensured that 50 percent or more of the fuel passes through the anode chamber unconsumed, absorbs generated product water and inert gases that have diffused through the membranes, and discharges them from the anode chamber. It is still ensured that the complete available active surface of the anode chamber securely and reliably comes into contact with hydrogen, and therefore its entire surface is utilized for generating electrical power.

In another very beneficial and advantageous embodiment of the method according to the invention, above the predefined load limit the anode chamber is supplied with less than 1.2 times, preferably approximately 1.05 times, the required fuel. Such a comparatively small excess of fuel, i.e., an anode stoichiometry of 1.05, ensures even in the average and full load ranges a sufficient pressure drop in the area of the anode chamber, so that water and inert gases are reliably discharged. On the other hand, the comparatively small value of approximately 1.05, for example, ensures that only a small quantity of hydrogen is not reacted in the area of the fuel cell and thus emitted to the environment.

In another very beneficial and advantageous embodiment of the method according to the invention, the exhaust gas from the anode chamber or the recirculation around the anode chamber is supplied to combustion, in particular catalytic combustion, the combustion exhaust gases being expanded in a turbine. The discharged excess hydrogen, which must be exhausted from the recirculation around the anode chamber, and which in particular in near-dead end operation leaves the anode chamber, may thus be supplied to combustion, in particular catalytic combustion. This takes place in particular in such a way that the exhaust gas containing the residual hydrogen together with the exhaust gas from the cathode chamber, which contains residual oxygen, is supplied to such combustion. As a result of the combustion, hydrogen emissions to the environment are avoided while appropriate use may be made of the pressure energy remaining in the exhaust gases and the thermal energy generated during the combustion of the residual hydrogen in the area of the turbine, for example to assist the air conveying device in driving the fuel cell system.

In another particularly beneficial and advantageous embodiment, the exhaust gas from the anode chamber or the recirculation around the anode chamber together with generated product water is discharged via a diaphragm and/or a valve device. The discharge may thus take place continuously or discontinuously. In particular when catalytic combustion is used, continuous discharge of the exhaust gas is preferred in each case, since this ensures uniform and reliable combustion and avoids highly fluctuating conditions in the area of the turbine. The recovery of energy from the exhaust gases or combustion exhaust gases is improved as a result.

### BRIEF DESCRIPTION OF THE DRAWING FIGURES

Further advantageous embodiments of the method according to the invention are described in greater detail below based on the exemplary embodiment with reference to the figures, which show the following:

FIG. 1 shows a schematic illustration of a fuel cell system suitable for carrying out the method according to the invention;

FIG. 2 shows the method procedure according to the invention in a first load range;

FIG. 3 shows the method procedure according to the invention in a second load range; and

FIG. 4 shows a diagram of the anode stoichiometry X as a function of the fuel cell current I.

### DETAILED DESCRIPTION

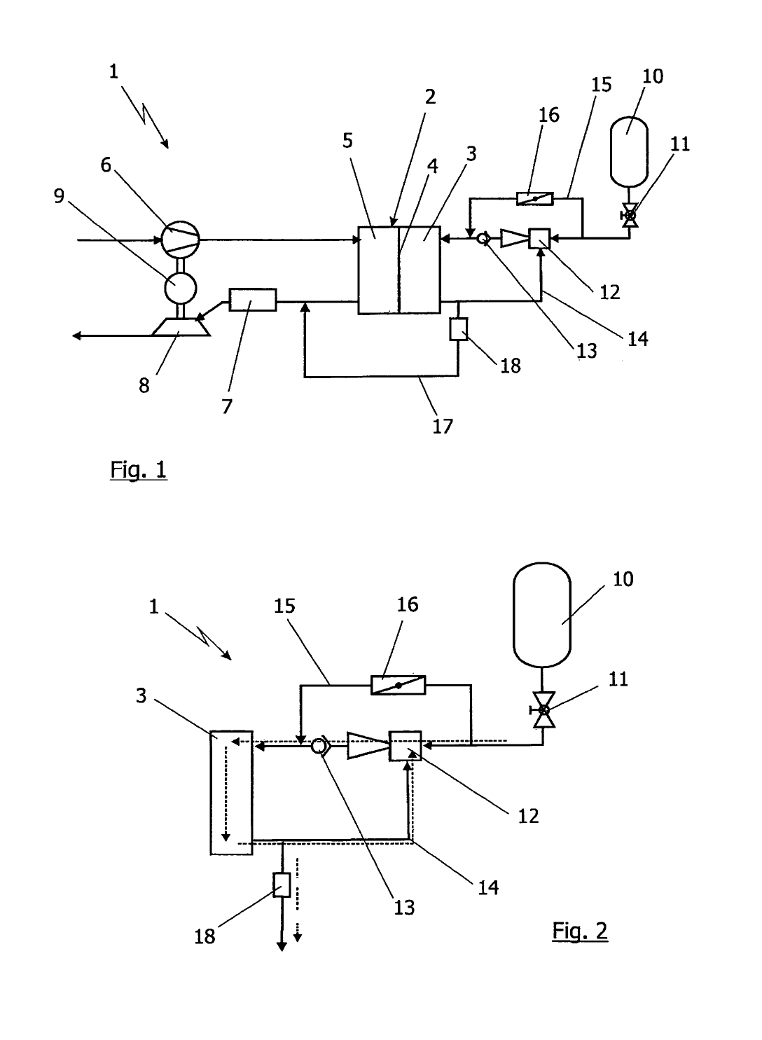

FIG. 1 shows a highly schematic illustration of a fuel cell system 1. The fuel cell system includes a fuel cell 2, which is designed as a PEM fuel cell, as an essential component. The fuel cell has an anode chamber 3, which is separated via proton-permeable membranes 4, from a cathode chamber 5 of the fuel cell 2. The fuel cell 2 is typically structured in such a way that it is designed as a stack of single cells, a so-called fuel cell stack.

The cathode chamber 5 of the fuel cell 2 is supplied with oxygen as the air supplier via an air conveying device 6. The unconsumed exhaust air from the cathode chamber 5, which always contains a certain quantity of residual oxygen, then flows into the area of a burner, preferably a catalytic burner 7. Here the unconsumed exhaust air is post-combusted together with hydrogen, which originates from the exhaust gases of the anode chamber 3 in a manner to be explained in greater detail below. The hot exhaust gases are expanded via a turbine 8. At least a portion of the pressure energy present in the exhaust gases and of the thermal energy present in the exhaust gases is thus utilized to drive the air conveying device 6, which is situated on the same shaft. In the typical operating states, the power generated in the area of the turbine 8 is not sufficient by itself for driving the air conveying device 6. Therefore, the turbine 8 and air conveying device 6 are typically also designed with an electric machine 9, which provides the remaining power necessary for driving the air conveying device 6. In situations in which more power is generated in the area of the turbine 8 than is required by the air conveying device 6, the electric machine 9 may also be operated as a generator and may provide electrical power on its own. The design comprising the air conveying device 6, electric machine 9, and turbine 8 is also referred to as an electric turbocharger or ETC.

The anode chamber 3 of the fuel cell 2 is supplied with hydrogen from a pressurized gas store 10 via a pressure control valve 11. This pressure control valve 11 is preferably designed as a continuous pressure control valve, not as a pulsed timing valve. Such a configuration of the pressure control valve 11 as a continuous pressure control valve, in contrast to a pulsed timing valve, allows distinct advantages with regard to the noise levels and vibrations caused by the pressure control valve 11. Downstream from the pressure control valve 11, the hydrogen flows into the area of a gas jet pump 12, and from there into the anode chamber 3 of the fuel cell 2 via a check valve 13. Exhaust gas from the anode chamber 3 of the fuel cell 2 may be led back into the area of the gas jet pump 12 via a recirculation line 14, and, together with the fresh hydrogen from the pressurized gas store 10, is thus resupplied to the anode chamber 3. In addition, the design of the fuel cell system 1 illustrated in FIG. 1 shows a bypass 15 having a valve device 16 around the gas jet pump 12, to be explained in greater detail below.

Over time, product water generated in the anode chamber 3 and inert gas diffused into the anode chamber 3 through the membranes 4 in the cathode chamber 5 become concentrated in the recirculation of the exhaust gas around the anode chamber 3. Since the volume of the recirculation is constant, the concentration of hydrogen inevitably drops, and the performance of the fuel cell 2 is diminished. It is therefore necessary to discharge gas from the area of the recirculation line 14, either discontinuously, intermittently, or as a function of certain parameters of the fuel cell system 1, or alternatively, continuously via a diaphragm, for example. An exhaust line 17, which may also be referred to as a purge line 17, is present for this purpose. By way of example, the illustration in FIG. 1 depicts a component 18 which may be, for example, a valve device and/or a diaphragm for discontinuous or continuous discharge of the exhaust gas from the area of the anode chamber 3 or the recirculation line 14. In any case, the exhaust gas will also contain a certain quantity of residual hydrogen. This exhaust gas is therefore mixed with the exhaust gas from the cathode chamber 5, and may be appropriately post-combusted in the above-described catalytic burner 7. In addition to the introduction of thermal energy into the combustion exhaust gases, which may be beneficially converted to mechanical power in the turbine 8, this post-combustion has the further effect that hydrogen emissions to the surroundings of the fuel cell system 1 are avoided.

As mentioned above, the illustration of the fuel cell system 1 is highly schematic, and is limited essentially to the parts that are required for explaining the invention. Of course, generally known and customary components such as a humidifier, various heat exchangers, water separators, and the like may be present in the fuel cell system, even though they are not illustrated here.

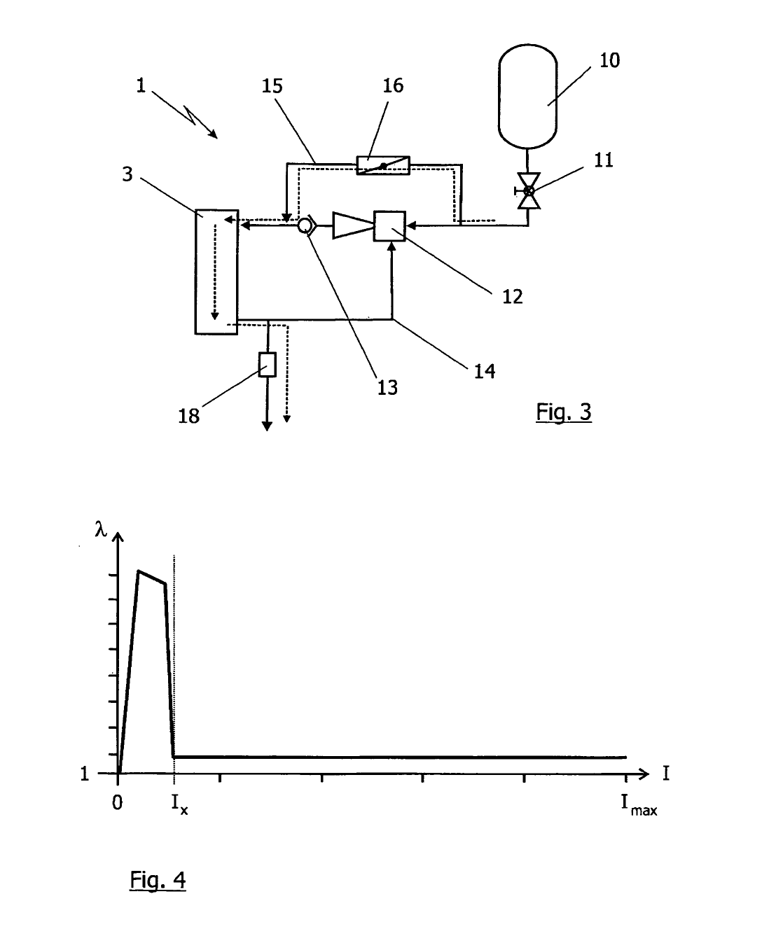

The fuel cell system described within the scope of FIG. 1 now allows essentially two different operating methods for its anode chamber 3, which are described below with reference to FIGS. 2 and 3. For purposes of explanation, FIGS. 2 and 3 show enlarged illustrations of only the areas that are relevant to the invention.

The illustration in FIG. 2 shows the operation in the part load range of the fuel cell system 1. The dashed-line arrows represent the flow of the hydrogen and the flow of the exhaust gas from the anode chamber 3 of the fuel cell 2. Within the meaning of the invention, part load of the fuel cell system 1 is understood to mean a load range in any case of less than 30 percent, preferably a load range between 5 and 20 percent, particularly preferably a load range below a limit value between 10 and 15 percent. The limit may be dimensioned in particular based on the current I generated by the fuel cell, which forms the X axis of the diagram in the illustration in FIG. 4. For a limit current Ix which corresponds to a predefined load limit and which is, for example, approximately 12 percent of the maximum current Imax of the fuel cell 2, part load operation of the fuel cell system 1 should be present.

In this part load operation which is present below the limit current Ix, operation should be carried out as shown in the illustration in FIG. 2 of the relevant detail of the fuel cell system 1. The comparatively small gas jet pump 12, which therefore has a compact and simple design, is driven by the fresh hydrogen as a propulsion jet via the pressure control valve 11, which is designed as a continuous pressure control valve. The fresh hydrogen flows via the check valve 13 into the anode chamber 3, where it is reacted to a certain extent. As is apparent from the depiction of the so-called anode stoichiometry λ in the illustration in FIG. 4, operation in these areas is carried out with a comparatively high anode stoichiometry in the range of preferably greater than 1.5, preferably in the range of 1.7 to 1.8. This means that 1.7 to 1.8 times the hydrogen that is reacted in the anode chamber 3 is supplied to the anode chamber 3. Thus, the portion of the product water that is generated in the anode chamber 3 and of any inert gases which have diffused through the membrane 4 into the anode chamber 3, together with the excess hydrogen supplied to the anode chamber 3, is discharged from the anode chamber, and passes via the recirculation line 14 back into the area of the gas jet pump 12. The volume flow is drawn in by fresh supplied hydrogen, and together with same is resupplied to the anode chamber 3.

During extended operation of the fuel cell system 1 under these part load conditions, product water and inert gas become concentrated in the recirculation around the anode chamber 3, as a result of which the hydrogen concentration drops. To be able to maintain the performance of the fuel cell during continued operation at part load, a portion of the media from the recirculation around the anode chamber 3 must be either continuously exhausted via a diaphragm or discontinuously exhausted via a valve device on an intermittent basis. As described above for the illustration in FIG. 1, this design comprising the diaphragm and/or valve device is illustrated by the component denoted by reference numeral 18 in the figures. The fact that either a small portion of the volume flow is continuously exhausted, or a portion of the volume flow is discontinuously exhausted on an intermittent basis, is indicated as an option in FIG. 2.

The operation of the fuel cell system in the manner described for FIG. 2, with a closed valve device 16 in the bypass 15, thus represents operation with recirculation of the anode exhaust gases. In the part load range below the limit current Ix of the fuel cell 2, this represents a preferred operating method, since secure and reliable discharge of product water from the anode chamber 3 may be ensured due to the large anode stoichiometry of greater than 1.5, despite the comparatively low volume flows. In addition, in this operating situation, which is comparatively critical for the membranes 4, humidification of same is achieved due to the recirculated water vapor, which together with the recirculated hydrogen is resupplied to the anode chamber 3. The hydrogen concentration in the recirculation around the anode chamber 3 may be regulated by the diaphragm or the valve device 18.

With increasing load or increasing fuel cell current I, above the predefined limit current Ix a switch is now made to an alternative operating method. This is depicted in the illustration in FIG. 3, here as well the material flows being indicated by the dashed-line arrows. The difference is essentially that the valve device 16 is open in the bypass 15. The hydrogen from the pressurized gas store 10 then no longer flows via the gas jet pump 12, but, rather, via the bypass 15 around the gas jet pump 12. Backflow of the hydrogen into the area of the gas jet pump 12 and the recirculation line 14 is avoided by means of the check valve 13. At the same time, the component 18, if it is a valve device, is correspondingly opened, or if the component 18 is a diaphragm, in this operating phase the exhaust gas from the anode chamber 3 flows out, typically continuously, via the component 18 and passes into the area of the catalytic burner 7 for appropriate post-combustion, as is apparent from the illustration in FIG. 1. The operating method at average loads, at higher loads, and at full load thus makes use of the anode chamber 3 as a type of near-dead end anode chamber 3, and dispenses with recirculation of the anode exhaust gases. The humidification, which may be achieved via the recirculation, is then eliminated, but in these operating states it is typically not needed. In addition, for the comparatively high pressure drops over the anode chamber 3 at the correspondingly high volume flows of the hydrogen, a comparatively small excess of hydrogen of less than 1.2, for example an anode stoichiometry of λ=1.05, is sufficient to completely discharge the product water from the anode chamber 3. This is apparent in the diagram of the anode stoichiometry λ as a function of the fuel cell current I in the illustration in FIG. 4.

Since the gas jet pump must now be operated solely in the part load range at comparatively low volume flows of the hydrogen, the gas jet pump may have a design that is correspondingly simple, compact, and therefore lightweight and inexpensive. Due to the method according to the invention, an additional recirculation conveying device or a parallel connection of multiple gas jet pumps for covering the entire load range, which must recirculate a very large volume flow, as is the case for average and high loads in the prior art, may be dispensed with in the design of the fuel cell system 1 illustrated here. Installation volume, weight, and parasitic power, for example for a hydrogen recirculation blower, may thus be spared.

Altogether, this results in a very simple and efficient design. The small quantity of excess hydrogen of 5 percent, for example, may be easily post-combusted in the catalytic burner 7, and for the most part also converted into usable power for the fuel cell system 1 in the turbine 8.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A method for operating a fuel cell system including a fuel cell having an anode chamber, a cathode chamber, and a recirculation system for recirculating anode exhaust gas from an outlet of the anode chamber to an inlet of the anode chamber, the method comprising:
determining a load of the fuel cell;
comparing the determined load of the fuel cell with a predefined load limit;
operating the fuel cell with recirculation of the anode exhaust gas from the anode outlet to the anode inlet when the load of the fuel cell is below the predefined load limit; and
operating the fuel cell without recirculation of the anode exhaust gas from the anode outlet to the anode inlet when the load of the fuel cell is between the predefined load limit and a full load of the fuel cell.

12. The method of claim 11, wherein the predefined load limit is up to 30 percent of a maximum fuel cell current at full load.

13. The method of claim 12, wherein the predefined load limit is between 5 and 20 percent of the maximum fuel cell current at full load.

14. The method of claim 13, wherein the predefined load limit is between 10 and 15 percent of the maximum fuel cell current at full load.

15. The method of claim 11, wherein the recirculation of the anode exhaust gas is maintained by a gas jet pump driven by an inflow of fresh fuel.

16. The method of claim 15, wherein above the predefined load limit the inflow of fresh fuel is achieved via a bypass around the gas jet pump.

17. The method of claim 11, wherein below the predefined load limit the anode chamber is supplied with an amount of fuel that is more than 1.5 time of a required amount of fuel.

18. The method of claim 17, wherein below the predefined load limit the anode chamber is supplied with an amount of fuel that is between 1.7 and 1.8 times of the required amount of fuel.

19. The method of claim 11, wherein above the predefined load limit the anode chamber is supplied with an amount of fuel that is less than 1.2 times a required amount of fuel.

20. The method of claim 19, wherein above the predefined load limit the anode chamber is supplied with an amount of fuel that is 1.05 times the required amount of fuel.

21. The method of claim 15, wherein the gas jet pump is supplied with the inflow of fresh fuel via a continuous pressure control valve.

22. The method of claim 11, wherein the exhaust gas from the anode chamber or the recirculation around the anode chamber is supplied to a catalytic combustion device and then to a turbine where the combusted exhaust gas is expanded.

23. The method of claim 11, wherein generated product water together with the exhaust gas from the anode chamber or the recirculation around the anode chamber are discharged via a diaphragm or a valve.
